(19) United States
(12) Patent Application Publication
(10) Pub. No.: US 2015/0127444 A1
(43) Pub. Date: May 7, 2015

(54) Method and System For Bundling Heterogeneous Demand At Discount

(71) Applicant: Ahmed Doha, Ottawa (CA)

(72) Inventor: Ahmed Doha, Ottawa (CA)

(21) Appl. No.: 14/533,068

(22) Filed: Nov. 4, 2014

Related U.S. Application Data
(60) Provisional application No. 61/899,463, filed on Nov. 4, 2013.

(51) Int. Cl. G06Q 30/02

(52) U.S. Cl. CPC G06Q 30/0223
USPC 705/14.24

(57) ABSTRACT

This disclosure comprises a method and system that enable providers of products and services to run effective and efficient discount campaigns when selling their products and services. The method and system in this disclosure accomplish this by enabling providers to bundle their heterogeneous products and/or services in bundles at a discount rate, that may vary across products and/or services within the same bundle, conditional on sales in a given bundle meeting a base dollar volume within a certain period of time specified by the provider offering the bundle. Executing the offered deals requires the accumulated dollar volume of the purchases to match or exceed the base dollar volume of sales within the specified period of time. Otherwise, the discounted bundle is deemed invalid, and accordingly, customers' purchases get canceled and the provider gets notified. Thus, the method and system in this disclosure guarantees providers minimum sales results for their discounted bundles of heterogeneous products and/or services.

This application is based on provisional patent application No. 61/899,463

### FIELD

This disclosure is in the field of aggregating customers' demand with the objective of obtaining a benefit, in particular a price discount.

### BACKGROUND

Aggregating customers' demand for products and/or services is associated with several benefits for both providers and consumers. One such benefit is price discount. Aggregated demand creates a large enough business for providers to offer price discounts, which is useful for customers who would pay less for what they need and is also useful for providers who would attract a bigger market to their products and/or services, improve their cash flow resulting from realizing quicker revenues, and increase their inventory turnover and hence their operational performance at least in terms of cost and flexibility.

Several prior patent grants and applications invented methods and systems that aim at aggregating customers' demand in order to qualify for associated benefits, especially the benefit of price discounts. This section presents an overview of the prior art with the objective of identifying the gaps and limitations that the current disclosure addresses.

In order to clarify the contributions of prior art and subsequently identify their limitations, prior art is categorized along the following four parameters.
1. Whether aggregation follows a grouping (of individual customers) or a bundling (of the demand of individual customers) approach.
2. Whether aggregation is done by customers or by providers.
3. Whether activation of the discount is contingent on any conditions (e.g. timeframe, group size, sales volume).
4. Whether direct negotiation between the providers and the customers is involved.

These four parameters are key design controllers in discount-based demand aggregation. Different combinations of these parameters can result in unique discount-based demand aggregation methods and consequently different performance results.

For the purpose of illustration, two embedded matrices are used to categorize prior art along these four parameters, as shown in FIG. 1. A 2×2 matrix is used to categorize prior art along the first and second parameters. The two rows in this matrix correspond to whether the approach followed is one of grouping or bundling, and the two columns correspond to whether aggregation is done by the customers or by the providers. This 2×2 matrix results in four categories, which are denoted A, B, C, and D for ease of reference. Further, in each one of these four categories, a 2×3 matrix is used to further categorize prior art along the third and fourth parameters. The two rows in this matrix correspond to whether there is direct price negotiation between the providers and the customers is involved, and the three columns correspond to whether activation of the discount is contingent on meeting a limited timeframe, a minimum group size, or a minimum sales $ volume. This 2×3 matrix results in four categories, which are denoted 1, 2, 3, 4, 5, and 6 for ease of reference. Thus, category B2, for example, refers to patents that group homogenous demand where grouping is done by the customers where the discount applies contingent on a minimum number of buyers and where price negotiation between the customer and provider is involved. The purpose of this categorization is not to detail the contribution of each of the listed prior art, but rather to illustrate the distance and distinction between the prior art and the current disclosure along key parameters. As shown in FIG. 1, a patent can be listed under more than one category. For example, (Leach and Harmon, 2008) is listed under four categories as this patent application broadly addresses grouping by customers and also by providers where grouping is subject to time and group size contingencies.

The 2×2 categories are first discussed. Patents in both categories A and B offer methods and systems that group customers who have homogeneous demand for a particular product or a service. The subject of grouping in these patents is the customer where the size of a given group is determined by the number of customers who share an interest in buying the same product or service.

Patents in category A advocate that the grouping activity be done by the customers. In this category, customers manage the initiation and growth of the group and also manage the selection process from the offers received by providers to fulfill the group's need for that specific product or service. The methods in the greatest majority of patents in this category fall in categories A1 and A2 where a given group is considered valid for a discount if a minimum number of customers joined the group AND/OR if the minimum group size is met within a limited timeframe specified by the initiating customer. The methods in these patents also dictate a process of direct price negotiation between customers and providers whereby customers evaluate and negotiate providers' offers to fulfill the group's demand of a particular Some patents are listed under both A1 and A2 categories as their methods require both contingencies of the minimum number of buyers and the limited timeframe for the group to be considered valid for discounts.

Alternatively, patents in category B advocate that the grouping activity be done by the providers. In this category, providers offer a specific product or service for a group of customers to purchase. In this category, providers manage the initiation of the sale and also the growth of the group of customers who buy the product or service, which is the subject of the group. However, some patents in this category refer to individual customers within a group partaking in the marketing of the deal, by email and/or social networking. In category B patents, the provider sets the price of the product or the service. The patents under categories B1, B2, and B3 advocate methods that dictate a process whereby customers can negotiate the price set by the providers. However, the methods in the patents under categories B4, B5, and B6 do not require price negotiations. Notably, all the patents in the B category use the minimum number of customers who buy the specific product or service into the group as the cutoff necessary for the group to qualify for a discount. For example, the method in patents (Mason, 2013, 2012), assigned to Groupon Inc., which fall in the B5 category, executes a discount on a particular product or a service if a minimum number of customers, specified by the provider, purchased that product or service within a limited timeframe or otherwise the discount would not be executed.

Patents in both categories C and D offer methods and systems that bundle customers' heterogeneous demand of products and/or services. The subject of bundling in these patents is customers' demand rather than the customers themselves as in patents in categories A and B.

Patents in category C advocate that the bundling activity be done by the customers. In this category, customers manage the initiation and growth of the bundle and also manage the selection process from the offers received by providers to fulfill the bundled demand for products and/or services. The methods in patent under category C follow a variety of pricing strategies for the heterogeneous products and/or services, which are the subject of the bundle. The patents under categories C1, C2, and C3 advocate methods that enable customers to call the prices they are willing to pay, which are subject to direct price negotiation with the providers in response to the providers' offers. Various dynamic pricing methodologies are advanced by these patents to enable the customers and the providers to arrive at acceptable pricing for both parties. For example, in the method in (DU and Wang, 2013), assigned to Nokia Corporation, pricing is called by the customers and it is up to the providers to accept the pricing or proposed preferred pricing to the group of customers. In order for the bundle to be considered for further processing, the methods in the patents in category C2 require the group to reach a minimum number of customers while the methods in the patents under category C3 require the value of the bundle to reach a minimum sales volume, and some of the C2 and C3 category patents require a limited time frame to reach those minimums. Those patents are also listed under category C1. Notably, no patents could be identified in any of categories C4, C5, or C6 where no price negotiation is required.

Most importantly, the current disclosure identifies an arguably valuable category D, where the bundling activity would be done by the providers. In this category, providers would offer a bundle of their heterogeneous products and/or services for customers to purchase. Also in this category providers manage the initiation of the sale and also the growth of the purchasing activity of the bundled products and/or services. This can be done with various arrangements along the remaining two parameters (price negotiation and discount contingencies). Notably, to the best of the inventor's knowledge, no patent grants or applications currently exist in category D. This is where the current disclosure contributes. There are patents that disclose methods to create bundles of products and/or services targeting an individual customer (Li, 2008), (Snyder, 2010), (Ku, 2009), (Juliana et al., 2006), (Balbo and Carpenter, 2013), (Shen, 2013), (Chan et al., 2003), (Kajamohideen and Desai, 2012), (Banerjee and Dutta, 2002), (Sinha and Gong, 2011). However, these patents are not related to the field of the current disclosure, which discloses methods for the bundling of products and/or services targeting collaborative purchasing by a number of customers.

Also, this patent is concerned only with the field of collaborative purchasing and consumption. Thus, this discussion of prior art excludes patents that are concerned with individual's purchases.

Clearly, the process (methods) and outcomes of grouping/bundling homogenous/heterogeneous demand can differ significantly when done by customers compared to when done by providers. Accordingly, it is more appropriate to compare category D4 and D6, where the current disclosure belongs, and where grouping/bundling is done by providers, to other categories where grouping/bundling is also done by providers (e.g. categories B1-6, D1-3, and D5).

The following identifies the limitations suffered by the patents in category B where the current disclosure provides superior utility.

The methods in category B patents require all group members to be interested in buying the same product or service in order to join the group. Hence, these methods waste any opportunity to take advantage of the purchasing power of customers with heterogeneous demand for different products and services in joining the group, which would have helped activate the discount by reaching the group size cutoff prior to the deal expiry.

The methods in category B patents suffer a limitation in that the product or service, which is the subject matter of the group discount, has to be statically determined up front in order to attract potential buyers with shared interest in buying that product or service. Practically then, virtually no changes can be done to the product or service that is the subject matter of the group discount before the expiry of the offered discount. This is a limitation because if the product or service is not selling, there is little to nothing that the provider could do to tweak the design of the offer to attract more sales.

The methods in category B patents suffer a limitation in that potential buyers who share a similar interest in purchasing a specific product and/or service are bound by one configuration/brand of that product and/or service that would result in the same price for all. As a result, the methods in these patents leave little to no room for a group member to customize his/her purchase of the product or service, especially when such customization would result in a different price than the price offered by the provider, which corresponds to a certain configuration. Also, following the methods in category B patents, providers are unable to offer different brands of the same product in a group discount because different brands likely have different prices. As a result, these methods would not perform favorably in a heterogeneous demand setting, which is the dominant setting in dynamic and free markets.

The methods in category B patents is likely ineffective in the case of a low-demand niche product or service. The low demand on such product or service makes it unlikely for providers following these methods to attract a large enough group in order to meet the discount cutoff size.

The methods in category B patents is inefficient from a marketing operations standpoint. Following these methods, a provider would have to run a separate discount campaign (to form a large enough group) for each one of the products and/or services that the provider would like to offer for a discount. Such can be a resource-intensive and unsustainable endeavor especially for resource-deprived businesses.

The following identifies the limitations suffered by any patents that would be listed under categories D1-3 and D5, where the current disclosure provides superior utility. Notably, no patent grants or applications could be identified in these categories.

Category D1-3 involves direct price negotiation between customers and providers. While such negotiations could have some usefulness, they can be lengthy with uncertain results. A few negotiations failing to reach an agreement on price would mean that the group size will keep fluctuating around the cutoff size. Such could lead to frustrating other customers, which could result in withdrawing from the group and for the whole domain of group discounting.

Category D5 sets the cutoff as the minimum number of units sold. Arguably, the use of the number of units sold or the number of purchasers is limiting due to the different nature of products and/or services that could be found in a bundle. The current disclosure identifies the sales dollar volume to be the most appropriate type of cutoff in a bundle setting, as will be explained in the remaining sections.

This section provides background information related to the present disclosure, which is not necessarily prior art.

### SUMMARY

This section provides a general summary of the disclosure, and is not a comprehensive disclosure of its full scope or all of its features.

This disclosure provides a method and system that enables a provider of products and/or services to bundle their heterogeneous products and/or services for a discount if a base dollar volume of sales of the products and/or services in this bundle is committed by potential buyers within a limited timeframe specified by the provider. The method in this disclosure enables providers to run effective and efficient discount campaigns with the objectives of clearing inventory and/or marketing their business and/or marketing newly introduced products and/or services. Furthermore, the system offers providers an offsite outlet 24×7 yearlong to run their in-season and out-of-season discount campaigns. The method and system in this disclosure achieve a plethora of benefits to providers and consumers beyond the benefits of related prior art and fix the limitations identified in prior art, as explained in the benefits section.

The method starts by giving providers of products and/or services permission to provide their products and services for a discount to the system users after agreeing to the terms and conditions of the system. A bundle of products and/or services is the unit based on which the method is based. A bundle is characterized by its collection of products and/or services available for potential buyers to purchase, the quantities of each one of the products and services that are available through this bundle, the discount rate that applies to each product and/or service (each product or service can be discounted at a rate that differs from the discount rates on the other products and services within the same bundle), the base dollar volume necessary to activate the bundle, the lifetime of the bundle, and the conditions of the bundle. A bundle may contain the entire catalogue of a given providers' products and/or services or a subset thereof. Each product or service in a given bundle can have a unique regular price and a unique discount rate. A potential buyer may buy one or more of the products and/or services available in a given bundle. A potential buyer can customize the configuration of the product and/or service before making the purchase. For example a potential buyer can specify the quantity, colors, and options of a given product prior to making the purchase. Different potential buyers can purchase different products and/or services in different quantities from one another. These products and/or services in a bundle can have different prices and delivery modes. The discount offered on the different products and/or services in a given bundle is conditioned on a base dollar volume of purchases made by potential buyers of these products and/or services available in the bundle. The base dollar volume is the sales volume of the provider's products and/or services in a given bundle that is necessary to activate the bundle. The dollar value of potential buyers' purchases of product(s) and/or service(s) in a given bundle is accumulated by the system and is continuously compared against the base dollar volume specified by the provider. If the base dollar volume is not reached within the bundle's limited lifetime, then the bundle is considered void and all buyers' purchases in the bundle are considered cancelled. On the other hand, if the base dollar volume of the bundle is reached within the lifetime of that bundle, then the bundle is activated.

In meeting the base dollar volume, the number of purchasers of a given product or service is irrelevant since a product or a service may have as few as one buyer. Yet the base dollar volume can still be reached within the lifetime of the bundle as a result of the purchase of other products and/or services offered in the same bundle. Also, in meeting the base dollar volume of a given bundle in order to activate the bundle, not every product or service in the bundle must be sold. The bundle can be activated if any combination of products and/or services is sold to the extent that the base dollar volume is reached. At the same time, the system does support agreements with the providers where activating a bundle can be conditioned on a certain volume of sales of specific products and services within the bundle.

Before sales in a given bundle reach the base dollar volume, when potential buyers purchase a product(s) and/or a service(s) in the bundle, an authorization is obtained on the purchase price from the potential buyers' payment facility like a credit card. The authorization places a hold on the purchase price for a period of time equal to the lifetime of the bundle. If the base dollar volume of the bundle is not reached within its lifetime, then prior authorizations on the purchase price and their associated holds on the funds on the buyers' payment facility are voided. If this was the case, then the provider is notified of the cancellation of the bundle. On the other hand, if sales in the bundle reach the base dollar volume, then the purchase price for all buyers is captured from their payment facility, like a credit card, and the payment is settled. Upon capturing the purchase price from the buyers, the buyers receive a confirmation of purchase by email or other forms of communication as a receipt that the buyers can use to claim the purchased product(s) and/or service(s) from the provider. The funds are received in the system's bank account. The system pays the provider their agreed upon share of the funds after retaining the apparatus' agreed share.

Upon reaching the base dollar volume, the provider may continue running the bundle until the remaining quantities sell out or the lifetime of the bundle elapses, whichever happens sooner. Different discount rates can be offered depending on sales volume. For example, a given product and/or service in the bundle can have one discount level for a given base dollar volume and a higher discount level for a higher base dollar volume of sales. Also discount differentiation techniques can be used to incentivize earlier purchasers in a given bundle.

The bundling activity in this disclosure can be administered on a third-party system (e.g. website on the internet or others) and/or on the providers' systems (e.g. providers' website on the internet or others) and/or on the systems that belong to other affiliates of the providers and/or of the third-party system in this disclosure, including customers who made purchases in the discounted bundles and other members from the public.

The system also provides each provider with a profile which acts as an online point of presence from which to run discounted bundles and build customer base. This profile maintains the provider's related records on the system including the providers' current bundles, general information, fans, reviews, and links to social media. On the other hand, the system also provides registered users (potential buyers) of the system with a profile where they can maintain their general information, prior purchases, a list of the product(s) and/or service(s) they wish to purchase, and a list of their friends from other social media platforms such as Facebook and Twitter. Friends of a given user may leverage information about the user's wish list in gifting that user from that list in special occasions like birthday or Christmas.

The system also provides providers with an algorithm that uses the data collected in suggesting to different providers best practices in bundling. For example, based on archival data collected, the algorithm can inform providers how much better a product or a service sells if bundled with other specific product(s) and/or service(s) and also how much better or faster a product or a service sells at various discount levels.

The system also provides its registered users with the ability to build their wish list. This wish list gets added to users' profile and can be purchased by their friends as gifts. Furthermore, the system provides its registered users with ability to inform their social networks about the current discounted bundles of products and/or services with the objective of speeding the activation of a bundle by attracting more sales to achieve the base dollar volume of sales in the bundle.

Benefits of the Disclosure (Volume-Based Bundling)

The bundling method in this disclosure enables providers to run discounts on their catalogue of heterogeneous products and services, knowing that they will be guaranteed at least a base dollar volume. This is useful for providers since in many cases, they cannot anticipate the sales volume that could result from offering a discount, which can negatively affect profitability if the sales volume at the discounted rate was not large enough.

One object of the bundling method in this disclosure is to enable providers to attract new markets to their business by discounting a variety of their products and services so that new customers may try or sample the providers' offerings at lower prices.

One object of the bundling method in this disclosure is to enable providers to market their newly introduced products and/or services by offering them at a discount for a guaranteed base dollar volume of sales of a bundle of these newly introduced products and/or services, which could also be bundled with existing products and/or services.

The bundling method in this disclosure gives providers an offsite place to run discounts on their catalogue of heterogeneous products and services with the objective of clearing inventory. Onsite discounts is usually associated with considerable marketing costs including signage printing, layout changes, operational disruptions, extended store hours, increased overtime pay especially over holidays. Accordingly, the proposed bundling system is envisioned to be the 24×7 marketplace for providers to run their sale/discount including holidays, such as Christmas, without the burden of having to open doors during sale seasons like Christmas.

The bundling method in this disclosure enables consumers to piggyback on each other's demand to obtain a discount on the products and/or services they are interested in purchasing, even if the demand is heterogeneous across those consumers.

The proposed bundling method has superior benefits that are useful advances to the limitations suffered by prior grouping methods as follows

Prior group discount methods suffer a limitation on the content of the group. Prior methods enable providers to sell a product or a service at a discount if a minimum number of potential buyers purchased that product or service. In other words, following prior methods, in order to get the group discount, every member of the group would be buying the same product or service. So, if a potential buyer of a given a product or a service that is not the subject matter of a given group, then that user cannot or would not join that group. In sharp contrast, the proposed bundling method alleviates this limitation by enabling providers to offer bundles of different products and/or services for a discount if a base dollar volume of sales in that bundle was purchased. Accordingly, different potential purchasers of different products and/or services can jointly benefit from the discount by purchasing from the same bundle to help each other reach the base dollar volume. Accordingly, while prior methods group potential buyers, the proposed method bundles products and services demanded by those potential buyers.

Prior group discount methods suffer a limitation in that the product or service, which is the subject matter of the group discount, have to be statically determined up front in order to attract potential buyers with shared interest in buying that product or service. No changes can be done to the product or service that is the subject matter of the group discount before the expiry of the offered discount. In contrast, in the proposed bundling method, while an initial set of products and/or services need to be determined up front as the subject matter of the bundle, the provider can, during the lifetime of the bundle, dynamically add more products and/or services to the bundle in order to attract greater sales volume that could help activate the bundle before exceeding its lifetime.

The proposed bundling method can offer providers considerable operational advantages including cost, flexibility, and delivery advantages. This is especially the case for product and service bundles that share production and logistics resources and capabilities. For example, the Print House in a typical university usually receives separate sporadic orders from student clubs to print various types of publications such as flyers, business cards, postcards, brochures, and posters. These products share the need for printing paper. Processing sporadic orders usually results in paper waste among other forms of waste. However, if Graphics Services offered its services in bundles of those different sized products, then receiving bundled orders of heterogeneous products and services would enable Graphics Services to fit several of these orders in the same print job and hence better utilize paper resources more efficiently. Thus, providers can use the proposed bundling method in judiciously bundling products and/or services that could synergistically result in such operational efficiencies. Consequently, the proposed bundling method enables providers to offer discounts that are the result of not only reduced profitability, but also and more importantly the result of operational cost reduction.

The proposed bundling method offers providers greater discount flexibility. For example, a given product and/or service can have one discount level for a given base dollar volume and higher discount levels for higher base dollar volumes. Also discount differentiation techniques can be used to incentivize earlier purchasers in a given bundle.

Prior group discount methods suffer a limitation in that potential buyers who share a similar interest in purchasing a specific product and/or service are bound by one configuration of that product and/or service that would result in the same price. In contrast, the proposed bundling method enables providers to offer different configurations of their products and/or services in a bundle which would result in different price per purchase across potential buyers. For example, the proposed bundling method enables a provider to offer a bundle of various brands and features such as colors and sizes for potential buyers to customize.

The proposed bundling method enables providers to run discounts on low-demand products and services by bundling them with higher-demand products and services and hence increasing the inventory turnover rate, decreasing holding costs, and consequently increasing net income, profitability, and market value. On their own, low-demand products and services are likely hard to find a big enough crowd of potential buyers for. However, by bundling with high-demand products and services, low-demand products and services can piggyback on bigger crowds to reach a base dollar volume that can allow a discount.

Compared to prior grouping methods, the proposed bundling method is faster in reaching the threshold that enables a discount. Whereas prior grouping methods enable a discount if a minimum number of potential buyers purchase a specific product or service, the proposed bundling method activates a bungle if a base dollar volume of sales of a variety of products and services is reached. Given the distributed nature of demand, finding demand for multiple products and services is more likely than finding demand for an individual product or service.

The proposed bundling method is more sustainable to providers' operation than prior grouping methods as it enables providers to sell various products and services in one discounted transaction, compared to prior grouping methods, which enable providers to sell only one specific product or service in a given discounted transaction. Accordingly, the proposed bundling method is superior to prior grouping methods in increasing inventory turnover of the entire catalogue of products and in increasing resources utilization for the entire catalogue of services.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 features a block diagram that illustrates the interaction between providers and customers on the system.

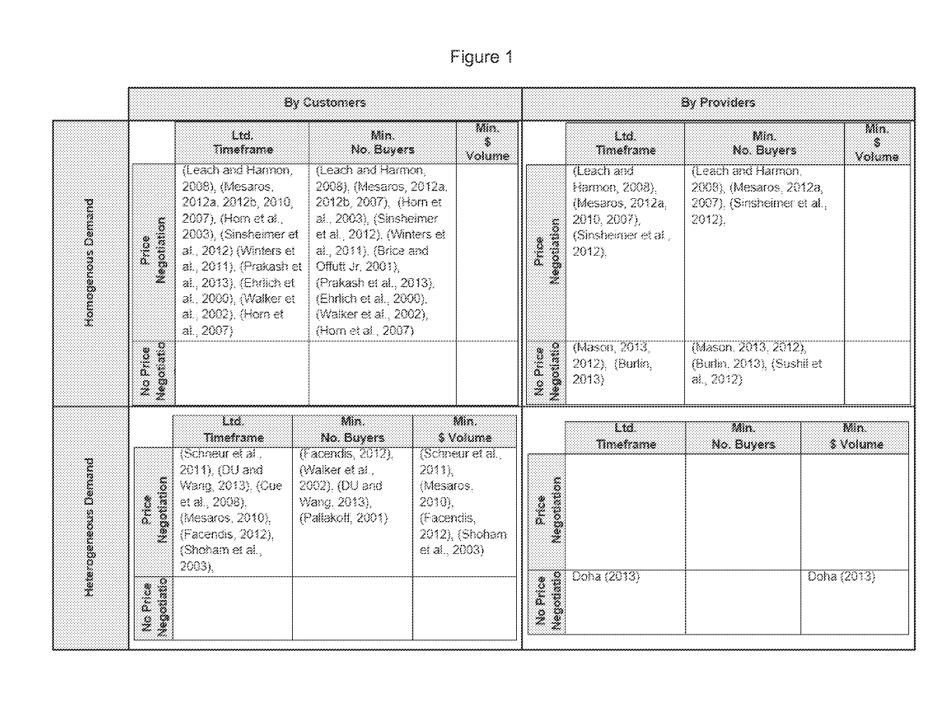

FIG. 2 illustrates a process flow chart of the proposed bundling method in this disclosure.

FIG. 3 illustrates the main categories of current patent grants and applications on demand aggregation methods.

FIG. 4 is an example webpage illustrating different products and/or services in a given bundle; and

FIG. 5 is an example of an affiliate's webpage

Corresponding reference numerals indicate corresponding parts throughout the several views of the drawings.

### DETAILED DESCRIPTION

Example embodiments will now be described more fully with reference to the accompanying drawings.

### DEFINITIONS

Products: tangibles including raw material, parts, and finished and unfinished goods.
Services: intangibles including pure services including but not limited to training, financial services, health care, pet care, arts and entertainment and also those services associated with goods including but are not limited to auto service, telecom services, dining, etc.
Provider: A business or an individual who provides a service or procures a product.
Base Dollar Volume: the minimum dollar volume of sales in a given bundle of products and/or services specified by the provider to activate the sale of the bundle.

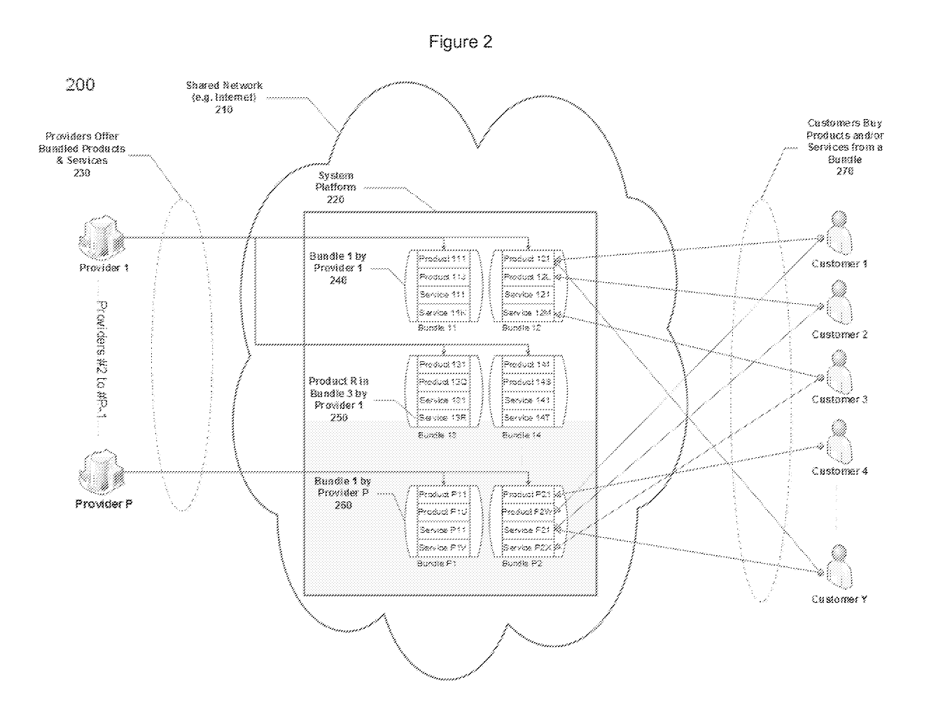

A first preferred embodiment is shown in the block diagram 200 in FIG. 2. A shared network such as the internet 210 is used to host the system platform 220 in order to reach communities of providers and customers. Providers post their bundles of products and services 230 on the system platform in order to be marketed by the system and in order to be accessed and purchased by the customers. A provider may have multiple bundles running on the system platform simultaneously. A bundle may contain a combination of individual products and/or services. For example, embodiment 240 shows one of the bundles offered by a given provider, which comprises J number of products and K number of services. Embodiment 250 points to an individual service that is being offered in another bundle by the same provider. Embodiment 260 points to a different bundle offered by another provider on the system platform. Those bundles offered by the different providers on the system platform are made available for access and purchase by customers 270 from the public. As shown in embodiment 170, different customers may purchase different products and/or services in a given bundle. A given customer may purchase the same or different products and/or services in more than one bundle at the same time.

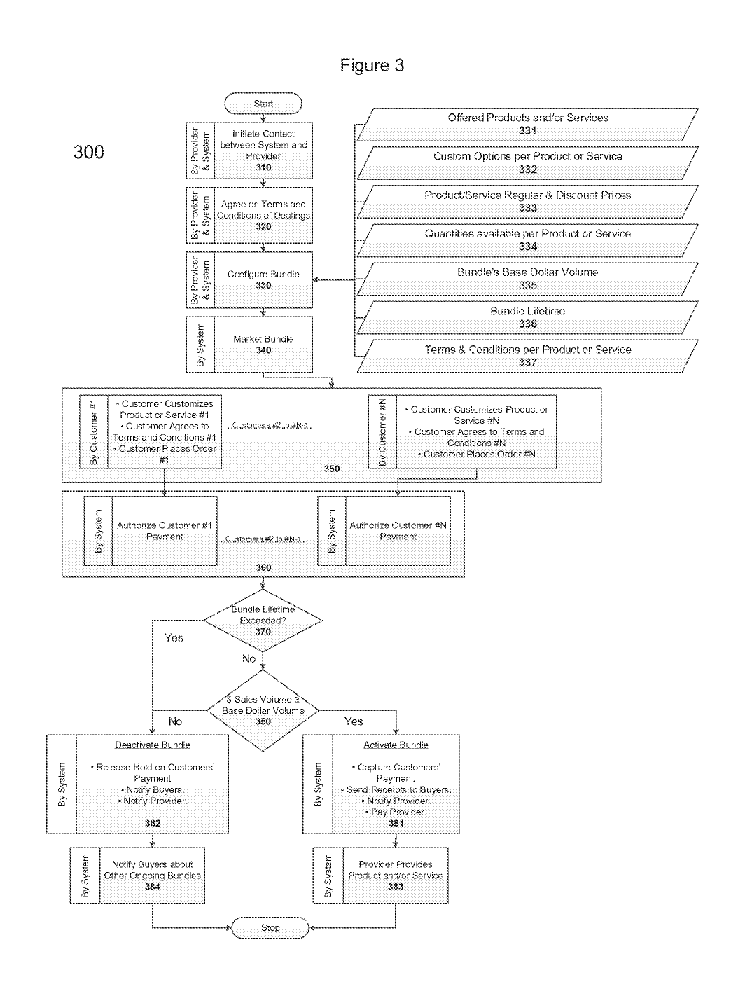

FIG. 3 is a process flow chart depicting an example method for bundling heterogeneous demand. The process starts by initiating contact between the system and a provider of products and/or services as in process 310. Initial contact can be initiated by either the system or by the provider. In process 320, upon getting the provider's interest in bundling his/her products and/or services for a discount using the system, the system and provider agree on the terms and conditions that protect the parties' interests including those of potential customer. In process 330, upon agreeing on the terms and conditions, the provider and the system collaborate in designing the bundle. In doing so, the provider provides basic information including

The products and/or services available for the bundle (process 331). A bundle may contain a combination of products and/or services. For example, in a hypothetical case, Sears Department Stores may wish to use the system to create a discounted bundle of different appliances (washers, driers, dish washers) and home services (carpet cleaning, and duct cleaning), all in one bundle.

Custom options per product or service (process 332). These are the customization options available for each product or service in the bundle. In the Sears example, there may be four different brands of washers, three different brands of driers, one brand of dish washers, three options of carpet cleaning (room, staircase, enlarged reception), and two options of duct cleaning (1500-2500 sf home, 2501-3500 st home).

The regular and discounted prices of each product or service in the bundle (process 333). In the Sears example, that would be the regular and discounted price of each of the washers, driers, dish washers, carpet cleaning, and duct cleaning.

The quantities of each product and/or service that are available for the bundle (process 334). Different quantities for different products and/or services in the bundle may be made available by the provider. In the Sears example, there may be 50 washers, 50 driers, 10 dish washers, 70 units of carpet cleaning, and 40 units of duct cleaning.

The base dollar volume sales in the bundle (process 335). This is the base dollar sales volume in the bundle at/beyond which the discounted bundle is considered valid and less than which the discounted bundle is considered invalid. In the Sears example, the base dollar volume could be $1,000,000 but can be any other figure too.

Bundle lifetime (process 336). This is the duration of time within which the bundle is available for sale. If sales of the different products and/or services in the bundle reached/exceeded the base dollar sales volume specified by the provider within the bundle lifetime specified buy the provider, then the discounted bundle is considered valid. Otherwise the discounted bundle is considered invalid. In the Sears example, the bundle lifetime could be two weeks but can be any other figure. If sales of the different appliances and home services reached/exceeded $1,000,000 within two weeks, then the discounted bundle is considered valid. Otherwise, the discounted bundle is considered invalid.

Terms and Conditions for each product or service (process 337). Each product or service in a given bundle may have its own terms and conditions.

Upon finalizing the bundle's design and content in process 330, the system markets the bundle through its channels (process 340), which include but are not limited to the system's website and the system's Application Programming Interface (API) widget hosted on the system's affiliate websites. Then, as in process 350, the system starts receiving customers' orders for the different products and processes in the bundle. In process 350, customers who place orders for products and/or services in the bundle are uniquely identified from 1 to N, where N can be any value and is not known upfront at the creation of the bundle. Each customer can customize the product or service of interest based on the options offered by the provider in process 330. In the Sears example, one customer may buy one brand of washers and another customer may buy a different washer brand. In the same bundle, a third customer may buy one of the drier brands. Also, in the same bundle, a fourth customer may customize the carpet cleaning service to five rooms while a fifth customer may customize the same service to three rooms, two staircases, and an enlarged reception. The fourth and fifth customers may end up paying different prices for their customization of the same kind of service. After customizing his/her product(s) and/or service(s) of interest, each customer agrees to the terms and conditions that pertain to each product or service. Terms and conditions may vary across different products and/or services in the same bundle. Following that, customers place their orders and provide information about their payment facility, which could be a credit card a debit card, or others.

Upon a customer's placement of his/her orders, the system verifies the authenticity of the customer's payment information and authorizes the dollar amount of the purchase on the customer's payment facility, which may include placing a hold on the dollar amount of the purchase (process 360). At this stage, the purchase amount does not get captured by the system from the customer's payment facility yet. However, the authorization represents a binding agreement on the customer to complete the purchase transaction, allowing the system to capture the purchase amount from the customer's payment facility at a later stage if and when the base dollar volume is met within the bundle lifetime.

The system keeps on accumulating the dollar value of customers' orders in the bundle in processes 350 and 360 while continuously checking if the bundle lifetime is exceeded (process 370). If the dollar volume of sales in the bundle reaches/exceeds the base dollar volume (process 380) within the bundle lifetime (process 370), then the bundle is deemed valid and the system activates it (process 381). Activating a bundle comprises the following activities:

The system captures the amounts of customers' purchases from their payment facility based on the prior authorization obtained.

The system sends a receipt to each customer documenting the products and/or services purchased which the customer can use to claim those products and/or services from the provider.

The system notifies the provider with the activation of the bundle and sends the provider a bill of customers' purchases of the various products and/or services in the bundle, customers' customizations of each product or service, customers' shipping and/or service address(s).

The system pays provider their agreed upon share of the proceeds of the sales achieved in the bundle.

Following process 381, the provider begins to provide each customer with his/her purchased product(s) and/or service(s) (process 383).

On the other hand, if the dollar volume of sales in the bundle fails to reach the base dollar volume (process 380) within the bundle lifetime (process 370), then the bundle is deemed invalid and the system deactivates it (process 382). Deactivating a bundle comprises the following activities:

The system cancels prior authorization and releases the hold on the amounts of customers' purchases placed on their payment facility.

The system notifies the customers that their earlier orders are cancelled and that no payment will be taken out of the payment facility they used to place the orders.

The system notifies the provider with the deactivation of the bundle.

For deactivated bundles (process 382), the system suggests other bundles with similar products and/or services to the customers whose orders have been cancelled (process 384).

An alternate embodiment is similar to the preferred embodiment in 300 but with distinctions. In this alternate embodiment, providers offer two discount rates for each product or service in a given bundle. The higher discount rate will apply if the accumulated dollar volume of customers' purchases in a given bundle was equal to or greater than the base dollar volume of sales within the specified period of time. However, the lower discount rate will apply if the accumulated dollar volume of customers' purchases was less than the base dollar volume of sales within the specified period of time. Accordingly, whereas the original preferred embodiment in 300 results in customers' purchases of discounted good and/or services going through if and only if the sales volume condition is met, this alternate embodiment results in customers' purchases going through anyway, albeit at a lower discount rate if the sales volume was condition was not met and at a higher discount rate if the sales condition was met.

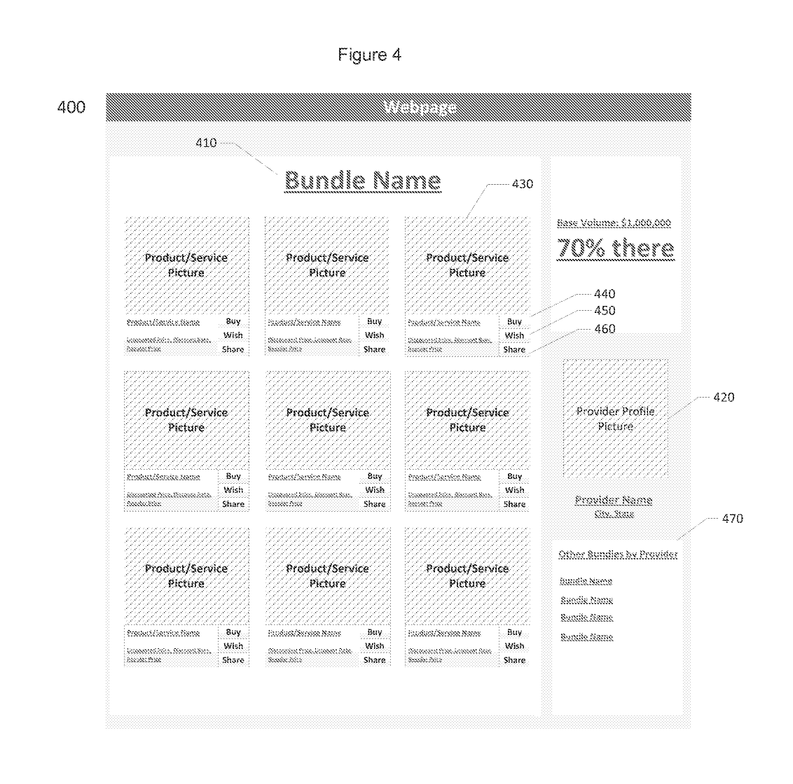

A third preferred embodiment is a webpage 400, as shown in FIG. 4, showing the different products and/or services in a given bundle by a given provider. Embodiment 410 shows the bundle name, which is chosen by the provider in coordination with the system and that distinguishes this bundle from other bundles offered by the same provider. Embodiment 420 shows the provider's identity including its profile picture, name, city, and state/province. Embodiment 430 shows the name and pricing (discount vs. regular prices and discount rate) information about a given product or service that is part of the bundle. The regular price, discount price, and/or discount rate of a given product or service can differ across the different products and/or services in the same bundle. Embodiment 440 shows a buy button which takes the customer to another page where the customer can customize the product or service, provide payment facility (credit card, debit card, etc) as well as shipping/service address information before finalizing the transaction. Embodiment 450 enables a customer to add a product or a service to his/her wish list. Embodiment 460 enables customers to share information about a product or service with their network via email or social networks to drive demand on the bundle partially with the objective of reaching the base dollar volume and activating the bundle. Embodiment 470 shows other bundles that are currently being offered by the provider on the system, if any, which is useful in taking advantage of customer's active presence on a given provider's bundle in marketing other bundles of the same provider.

The bundling activity in this disclosure can be administered on a third-party system (e.g. website on the internet or others) and/or on the providers' systems (e.g. providers' website on the internet or others) and/or on the systems that belong to other affiliates of the providers and/or of the third-party system in this disclosure, including customers who made purchases in the discounted bundles and other members from the public.

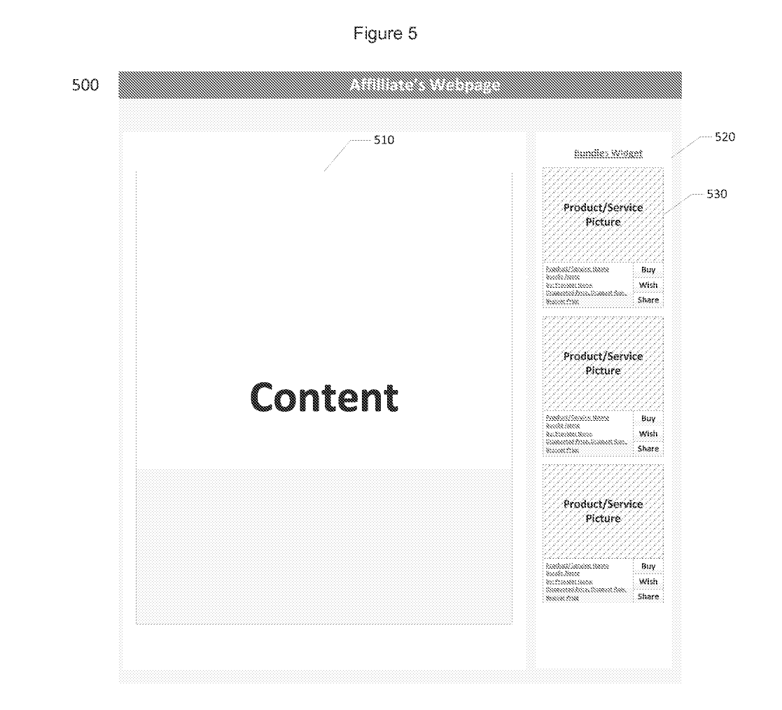

FIG. 5 is an example of an affiliate's webpage. A widget 520 can be hosted on the provider's as well as affiliates' systems, which include but is not limited to websites 500 on the internet. Aside from the affiliate websites' main content 510, the widget 520 gives users of those websites the capability to transact (buy, wish, share) on a given product or service 530 in a given bundle straightaway from those websites.

The techniques described herein may be implemented by one or more computer programs executed by one of more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively covey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent rom the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware, or hardware, and when embodied in software, could be downloaded to reside on and be operated from different platforms used by real time network operating systems.

The present disclosure also related to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICS), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the techniques herein, or it may prove convenient to construct more specialized apparatuses to perform the required method steps. The required structure for a variety of these systems will be apparent to those of skills in the art, along with equivalent variations. In addition, the present disclosure is not described with reference to any particular programming language. It is appreciated that a variety of programming languages may be used to implement the teachings of the present disclosure as described herein.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

REFERENCES

| | | |
|---|---|---|
| U.S. Pat. No. 20,040,205,003 A1 | October 2004 | Balbo et al. |
| U.S. Pat. No. 20,020,188,503 A1 | December 2002 | Banerjee et al. |
| U.S. Pat. No. 8,401,910 B2 | March 2013 | Burlin |
| U.S. Pat. No. 20,030,033,218 A1 | February 2003 | Chan et al. |
| U.S. Pat. No. 7,424,445 B1 | September 2008 | Cue et al. |
| U.S. Pat. No. 20,120,029,992 A1 | February 2012 | Facendis et al. |
| U.S. Pat. No. 6,604,089 B1 | August 2003 | Horn et al. |
| U.S. Pat. No. 7,194,427 B1 | March 2007 | Horn et al. |
| U.S. Pat. No. 7,103,566 B2 | September 2006 | Juliana et al. |
| U.S. Pat. No. 20,120,259,687 A1 | October 2012 | Kajamohideen |
| | | et al. |
| U.S. Pat. No. 20,090,327,064 A1 | December 2009 | Ku et al. |
| U.S. Pat. No. 20,080,097,826 A1 | April 2008 | Leach et al. |
| U.S. Pat. No. 20,080,119,200 A1 | May 2008 | Li |
| U.S. Pat. No. 8,301,495 B2 | October 2012 | Mason |
| U.S. Pat. No. 8,355,948 B2 | January 2013 | Mason |
| U.S. Pat. No. 7,181,419 B1 | February 2007 | Mesaros |
| U.S. Pat. No. 7,747,473 B1 | June 2010 | Mesaros |
| U.S. Pat. No. 8,160,931 B2 | April 2012 | Mesaros |
| U.S. Pat. No. 8,140,405 B2 | March 2012 | Mesaros |
| U.S. Pat. No. 6,269,343 B1 | July 2001 | Pallakaff |
| U.S. Pat. No. 8,036,950 B1 | October 2011 | Schneur et al. |
| U.S. Pat. No. 6,584,451 B1 | June 2003 | Shoham et al. |
| U.S. Pat. No. 8,015,070 B2 | September 2011 | Sinha et al. |
| U.S. Pat. No. 20,120,310,764 A1 | December 2012 | Sinsheimer et al. |
| U.S. Pat. No. 7,707,090 B2 | April 2010 | Snyder |
| U.S. Pat. No. 20,120,150,619 A1 | June 2012 | Sushil et al. |
| U.S. Pat. No. 6,466,919 B1 | October 2002 | Walker et al. |
| WO 2,001,077,958 A2 | October 2001 | Brice et al. |
| WO 2,013,037,108 A1 | March 2013 | DU et al. |
| WO 2,000,045,318 A1 | August 2000 | Ehrlich et al. |
| WO 2,013,101,192 A1 | July 2013 | Prakash et al. |
| WO 2,011,150,816 A1 | December 2011 | Shen |
| WO 2,011,044,512 A3 | September 2011 | Winters et al. |

1. Method and system that enable providers of products and services to run effective and efficient discount campaigns when selling their products and services. The method and system in this disclosure accomplish this by enabling providers to bundle their heterogeneous products and/or services in bundles at a discount rate, that may vary across products and/or services within the same bundle, conditional on sales in a given bundle meeting a base dollar volume within a certain period of time specified by the provider offering the bundle. Customers' purchases of the heterogeneous products and/or services in a given bundle are accumulated. The accumulated dollar volume of these purchases is compared to the base dollar volume of sales. If the accumulated dollar volume of the purchases was equal to or greater than the base dollar volume of sales within the specified period of time, then the discounted bundle is deemed valid, and accordingly, the provider gets paid and is prompted to start fulfilling customers' purchases of the heterogeneous products and/or services. However, if the accumulated dollar volume of the purchases was less than the base dollar volume of sales within the specified period of time, then the discounted bundle is deemed invalid, and accordingly, customers' purchases get canceled and the provider gets notified. Thus, the method and system in this disclosure guarantees providers minimum sales results for their discounted bundles of heterogeneous products and/or services.

2. Method and system that enable providers to offer two discount rates for each product or service in a given bundle. The higher discount rate will apply if the accumulated dollar volume of customers' purchases in a given bundle was equal to or greater than the base dollar volume of sales within the specified period of time. However, the lower discount rate will apply if the accumulated dollar volume of customers' purchases was less than the base dollar volume of sales within the specified period of time. Accordingly, whereas the method and system to those in claim 1 result in customers' purchases of discounted good and/or services going through if and only if the sales volume condition is met, the method and system to those in claim 1 result in customers' purchases going through anyway, albeit at a lower discount rate if the sales volume was condition was not met and at a higher discount rate if the sales condition was met.

3. Method and system to channel system's bundles on affiliate companies' websites through an Application Programming Interface (API) widget.
